(19) United States
(12) Patent Application Publication
(10) Pub. No.: US 2010/0090020 A1
(43) Pub. Date: Apr. 15, 2010

(54) Modular Water Fountain

(76) Inventor: Lisa Thompson, Colgate, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/252,307

(22) Filed: Oct. 15, 2008

(51) Int. Cl. B05B 17/08

(52) U.S. Cl. 239/17

(57) ABSTRACT

A modular water fountain system and apparatus having at least one interchangeable water flow unit, at least one interchangeable basin unit and at least one interchangeable base unit.

### CLAIM OF PRIORITY

This Application claims priority to U.S. Provisional Application No. 61/075,9698

### FIELD OF INVENTION

This invention relates generally to the field of water fountains, and in particular to a modular water fountain apparatus and system with modular components that can be interchanged, thereby creating personalized water fountains.

### BACKGROUND

Indoor water fountains are a popular home accessory because of their aesthetic appearance and the soothing effect of the sound of flowing water. In addition, a water fountain humidifies indoor air.

It is desireable for consumers of indoor fountains to have a range of choices with respect to the appearance of the base, water flow mechanism and basin of a fountain. It is efficient for consumers and manufacturers to have indoor fountain with independently functioning modular components which can can be ordered or seperately assembled, selected and interchanged to create visual effects and vary the size and shape of an indoor water fountain by virtue of the modular elements selected and their assembly.

As used herein the term “basin unit” refers to any component capable of holding water or other liquid, that may act as a storage for water as well as a splash-guard to prevent water from leaving the unit. The basin may be concave, rectangular, or any other shape capable of containing liquid. The basin unit may serve other functions, such as a bird-bath, a planter, an environment for aquatic animals, or other functions.

As used herein the term “base unit” refers to any unit made of any material that is capable of supporting and displaying a basin unit as well as having a means to securing to the basin unit through screws, bolts, grooves, holes, clips, or any means known in the art. The base unit may be made of a single or multiple pieces of material.

As used herein the term “power source” refers to any source of electrical power including a AC or DC power cord, a hidden or concealable power cord, a user-replaceable battery, an internal battery, a lithium ion battery, a solar power source or any other power source common to the art.

### BRIEF DESCRIPTION OF THE DRAWINGS

FIG. 1 is a side view of one exemplary embodiment of a modular water fountain.

FIG. 2 is a side view of one alternate embodiment of the modular water fountain illustrating three potentially interchangeable modular components.

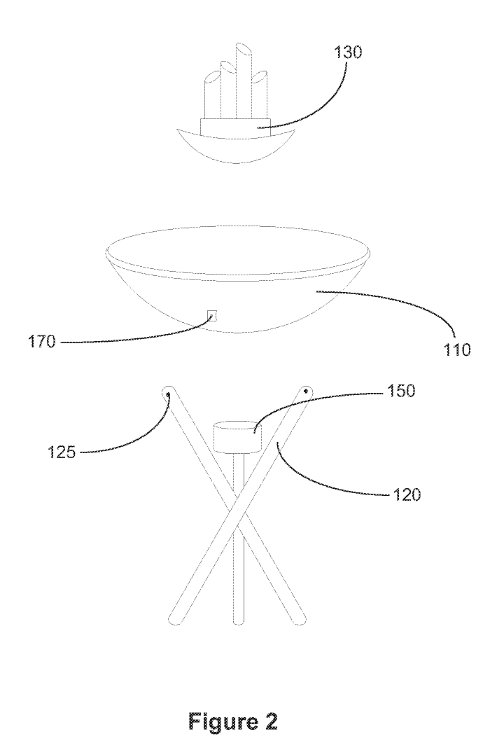

### DETAILED DESCRIPTION OF THE INVENTION

For the purpose of promoting an understanding of the present invention, references are made in the text hereof to embodiments of a modular water fountain, only some of which are depicted in the figures. It should nevertheless be understood that no limitations on the scope of the invention are thereby intended. One of ordinary skill in the art will readily appreciate that modifications such as the dimensions, size, and shape of the components, alternate but functionally similar materials from which the modular water fountain is made, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near indentical structural elements.

Moreover, the term “substantially” or “approximately” as used herein may be applied to modify any quantitative representation that could permissibly vary without resulting in a change in the basic function to which it is related.

While the modular water fountain has been shown and described with respect to several embodiments and uses in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

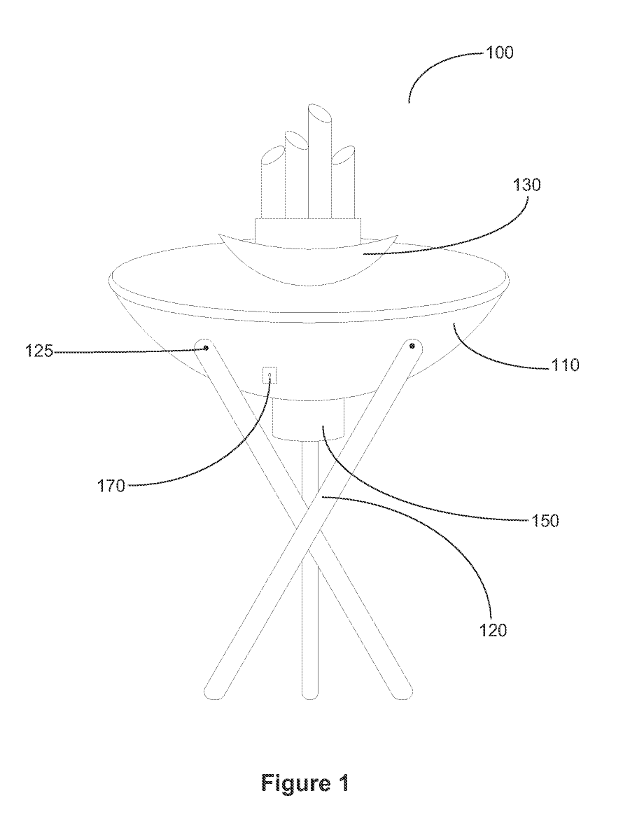

FIG. 1 illustrates one exemplary embodiment of modular water fountain system 100 including interchangeable basin unit 110 capable of being connected or resting upon interchangeable base unit 120 and secured by securing component. 125 which may be a screw, bolt, fitted groove, indentation or any other hardware device or configuration which provides stabilization but which is capable of allowing least one interchangeable basin unit 110 and interchangeable base unit 120 to be assembled or disassembled.

Also shown in FIG. 1 is water flow unit 130 known in the art which includes a tank or compartment capable of storing water and circulating it to provide the aesthetic effect of a fountain, and which further includes a power source 150 of a type typically know in the art. In the embodiment shown, power source 150 is a battery, but in other embodiments, power source 150 may include an electrical cord (not shown) which may be concealed or unconcealed. Other embodiments may include additional decorative elements or devices such as ornamentation or lighting.

Also shown in FIG. 1 is control switch 170 which may be disposed on interchangeable basin unit 110, base, unit 120 or water flow unit 130, or may be a remote control device or mounted wall switch. Control switch may activate the power of the device, as well as other aspects such as light, flow control, and additional features.

Other embodiments of the invention may include further aesthetic and functional components such as rock configurations, compartments capable of housing fish or plants, humidifiers, air fragrance or fresheners, silencing components, water coloring chemicals, lighting and components capable of emitting sound, music, steam or mist.

What is claimed is:

1. A modular water fountain apparatus comprised of:
at least one interchangeable basin unit configured with modular dimensions;
a means for securing said interchangeable basin unit to a base;
a water flow unit;
a moisture-resistant power source selected from a group consisting of a battery; an electric power source, a hydroelectric power source and a solar power source

2. The apparatus of claim 1, wherein said at least one basin is of a standardized size adapted to be used as an interchangeable component of said modular fountain apparatus.

3. The apparatus of claim :1, wherein said at least one water flow unit is of a standardized size adapted to be used as an interchangeable component of said modular fountain apparatus.

4. The apparatus of claim 1, wherein said at least one basin is of a standardized size adapted to be used as an interchangeable component of said modular fountain apparatus.

5. The apparatus of claim 1, wherein said at least one basin consists of consists of multiple basins wherein at least upper basin is positioned above a lower basin, and said at least one upper basin is smaller than said at least one lower basin.

6. The apparatus of claim 1, wherein said at least one basin consists of a basin consists of multiple basins wherein at least upper basin is fixedly mounted above a lower basin, and said at least one upper basin is smaller than said at least one lower basin.

7. The apparatus of claim 1, wherein said at least one basin consists of a basin consists of multiple basins wherein at least upper basin is fixedly mounted within a lower basin, and said at least one upper basin is smaller than said at least one lower basin.

8. The apparatus of claim 1, wherein said at least one basin has a radius within a range of 12 inches to 48 inches.

9. The apparatus of claim 1, which further includes a concealed power source and partially concealed wiring.

10. The apparatus of claim 1, which further includes a remote control power switch.

11. The apparatus of claim 1, which further includes decorative lighting selected from a group consisting of a halo light, lighting beneath said at least one basin and LED lights, light bulbs, light strips, light emanating material and phosphorescent material.

12. The apparatus of claim 11, which further includes said at least one base containing a contoured area to accommodate said decorative lighting.

13. The apparatus of claim 11, which further includes a basin containing a recessed area configured decorative lighting selected from a group consisting of a halo light, lighting beneath said at least one basin and LED lights, light bulbs, light strips, colored lighted, muted muting, adjustable-level light, lighting which gives the illusion of colored water flow, timed lighting, a reflective material and phosphorescent material.

14. The apparatus of claim 11, which further includes a water flow unit adapted to receive decorative lighting.

15. The apparatus of claim 14, which further includes a water flow unit with a water resistant housing adapted to receive decorative lighting.

16. The apparatus of claim 1, which further includes an electronic apparatus for creating the effect of steam rising from said at least one basin of said at least one interchangeable basin unit.

17. The apparatus of claim one wherein said base is constructed of a structure selected from a group consisting of a columnar structure, a hollow cylindrical structure, a non-cylindrical structure, a statue, a metal base, an ornamental metal base, a wooden base, an ornamental wooden base, a plastic base, an ornamental plastic base, a plaster base, a cement base, a stone base, a precious metal base.

18. A modular water fountain system comprised of:
at least one interchangeable basin unit, wherein said at least one basin is of a standardized size adapted to be used as an interchangeable component of said modular fountain apparatus;
a means for securing the basin to the base wherein said at least one base is of a standardized size adapted to be used as an interchangeable component of said modular fountain apparatus.
a water flow unit;
and a power source.

19. The system of claim 18, The apparatus of claim 1, wherein said at least one basin consists of a basin consists of multiple basins wherein at least upper basin is positioned above a lower basin, and said at least one upper basin is smaller than said at least one lower basin and each of said at least one basin has a radius within a range of 12 inches to 48 inches.

20. A modular water fountain apparatus comprised of:
at least one interchangeable basin unit, wherein said at least one basin is of a standardized size adapted to be used as an interchangeable component of said modular fountain apparatus;
a means for securing the basin to the base wherein said at least one base is of a standardized size adapted to be used as an interchangeable component of said modular fountain apparatus.
a water flow unit;
at least one concealed power source selected from a group consisting of a battery power source, a solar power source, an electrical power source and a hydroelectric power source.
